(19) United States
(12) Patent Application Publication
(10) Pub. No.: US 2009/0094385 A1
(43) Pub. Date: Apr. 9, 2009

(54) Techniques for Handling Commands in an Ordered Command Stream

(76) Inventors: Ronald E. Freking, Rochester, MN (US); Ryan S. Haraden, Rochester, MN (US); David A. Shedivy, Rochester, MN (US); Kenneth M. Valk, Rochester, MN (US)

Correspondence Address: IBM CORPORATION, 3605 HIGHWAY 52 NORTH, DEPT 917, ROCHESTER, MN, 55901-7829, US

(21) Appl. No.: 11/868,603

(22) Filed: Oct. 8, 2007

(51) Int. Cl. G06F 13/16

(52) U.S. Cl. 710/5

(57) ABSTRACT

A technique for handling commands includes assigning respective first tags to ordered commands included in an ordered command stream. Respective second tags are then assigned to subsequent commands that follow an initial command (included in the ordered commands). Each of the respective second tags correspond to one the respective first tags that is associated with an immediate previous one of the ordered commands. The initial command is sent to an execution engine in a first cycle. At least one of the subsequent commands is sent to the execution engine prior to completion of execution of the initial command.

### BACKGROUND

1. Field

This disclosure relates generally to ordered command streams and, more specifically to techniques for handling commands in an ordered command stream.

2. Related Art

As the performance levels for processor and input/output (I/O) traffic has continued to increase, integrated circuit (e.g., application specific integrated circuit (ASIC)) designers have found it increasingly difficult to meet internal performance requirements for IC designs, such as Northbridge designs. For example, in response to increased data transfer rates provided by high-speed serial interfaces, various IC designs have increased internal clock frequencies, redesigned internal queue structures, or have increased internal clock frequencies and redesigned internal queue structures in an attempt to meet the increased data transfer rates. Unfortunately, there are limits on internal clock frequencies and on internal queue structure sizes and complexity that may be practically achieved. As another approach to meet increased internal performance requirements, at least some IC designs have integrated I/O into memory subsystems. However, incorporating I/O into a memory subsystem may still not meet a throughput level required for a given application.

Moreover, when handling a command stream that is ordered (i.e., a command stream that include subsequent commands that may not be serviced until a previous command has completed), it is generally more difficult to design an IC to operate at a desired performance level than when a command stream is unordered. Furthermore, memory controllers of computer systems have typically not been configured to perform command ordering, as external requesters have usually enforced ordering on data flow, when required. Peripheral component interconnect (PCI) Express 2.0 is one example of an interface that employs ordered command streams. In a system that implements a PCI Express 2.0 bus having an x16 link, a performance level required to keep the x16 link fully utilized is about 7.5 gigabytes per second (GB/s) (in both in-bound and out-bound directions). In order to meet a 7.5 GB/s requirement on an internal IC interface with an internal clock frequency of 400 MHz, 64 bytes (B) of command and data must be executed about every 3.4 cycles. While a bus width may be increased, in order to meet a 7.5 GB/s requirement at a 400 MHz internal clock frequency, cache lines would need to be approximately 192B. However, it is generally not desirable to route a 192B bus across an entire IC (or chip). Moreover, in current ASIC designs, it is difficult to meet a 7.5 GB/s performance level for an ordered stream flowing from a PCI Express 2.0 interface.

In a stream of ordered commands in a non-ordered coherent design, commands are queued to execute on a cache line boundary. In this case, one command cannot begin executing until the previous command has completed. In order to service all coherent possibilities, it usually takes multiple cycles to discover a state of any given cache line. In general, the faster an internal clock frequency, the shorter the distance a signal can travel before requiring a latch/register set. Traditionally, a command in an ordered queue has been required to wait until a previous command has been requested, gained coherence, and received a response. Based on distances, boundaries, and internal clock frequencies, a command may require as many as ten cycles from request to response.

### SUMMARY

According to various aspects of the present disclosure, a technique for handling commands includes assigning respective first tags to ordered commands included in an ordered command stream. Respective second tags are then assigned to subsequent commands that follow an initial command (included in the ordered commands). Each of the respective second tags correspond to one the respective first tags that is associated with an immediate previous one of the ordered commands. The initial command is sent to an execution engine in a first cycle. At least one of the subsequent commands is sent to the execution engine prior to completion of execution of the initial command.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a block diagram of an example processor system that may be configured according to various aspects of the present disclosure.

FIGS. 2-3 include a flowchart of an example process for handling commands of an ordered command stream in the processor system of FIG. 1, according to various embodiments of the present disclosure.

### DETAILED DESCRIPTION

As will be appreciated by one of ordinary skill in the art, the present invention may be embodied as a method, system, device, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” The present invention may, for example, take the form of a computer program product on a computer-usable storage medium having computer-usable program code, e.g., in the form of one or more design files, embodied in the medium.

Any suitable computer-usable or computer-readable storage medium may be utilized. The computer-usable or computer-readable storage medium may be, for example, but is not limited to, an electronic, magnetic, optical, electromagnetic, infrared, or semiconductor system, apparatus, or device. More specific examples (a non-exhaustive list) of the computer-readable storage medium include the following: a portable computer diskette, a hard disk drive (HDD), a random access memory (RAM), a read-only memory (ROM), an erasable programmable read-only memory (EPROM) or Flash memory, a portable compact disc read-only memory (CD-ROM), an optical storage device, or a magnetic storage device.

In a traditional IC design of a Northbridge, the distance from a coherence part of a chip to a queue has required at least one set of latches for timing in each direction (request and response). Normally, there is at least one cycle for state look-up and another two cycles for command processing, which exceeds the cycles required to meet a 7.5 GB/s performance for an IC (chip) with an internal frequency of 400 MHz and a data bus of 64B. It should be appreciated that different designs have different breakeven points, depending on an internal clock frequency and I/O design. According to various aspects of the present disclosure, techniques are disclosed herein that facilitate 64B of command and data flow every three cycles (at a 400 MHz internal clock frequency), which provides a potential throughput of 8.5 GB/s on ordered streams.

According to various aspects of the present disclosure, each command that requires ordering (i.e., each command of an ordered command stream) is assigned a unique ID (tag) before presentation to a coherence unit, and each subsequent command is presented to the coherence unit with the assigned unique tag (for the subsequent command) and the tag of the previous command. In this manner, each command can be presented to the execution engine well in advance of the completion of a previous command, while maintaining an actual execution order of the commands in an ordered command stream. In general, subsequent commands with a tag of a previous command (that must completed before the subsequent command can complete) can be queued in the coherence unit. The queued command can then be executed as soon as the previous command reaches completion. In this manner, an ordered stream that is clocked at 400 MHz can provide 64B of command and data flow (i.e., a 64B cache line) every three cycles, which exceeds a 7.5 GB/s performance level.

It should be appreciated that the techniques disclosed herein are not limited to ICs having a 400 MHz internal clock frequency and/or a 64B cache line. The techniques disclosed herein are broadly applicable to speeding-up ordered streams of traffic within a memory controller (or other I/O chip), while at the same time not requiring significant changes in either buffering or queuing. Moreover, the techniques disclosed herein do not adversely affect a non-ordered flow for which a chip may have been optimized. It should be appreciated that the techniques disclosed herein are broadly applicable to cache line sizes that are more or less than 64B and internal clock frequencies that are more or less than 400 MHz.

As previously noted, a bottleneck exits when a command that is presented to a system (or subsystem) has to wait for execution until a previous command completes. According to various aspects of the present disclosure, commands (e.g., direct memory access (DMA) commands) in an ordered command stream are assigned a unique tag prior to presenting the command to an execution engine that is responsible for managing execution of the command (e.g., reading/writing from/to a memory subsystem). According to this approach, subsequent commands can be issued as long as a tag for a previous command is included with the subsequent command. In this manner, the execution engine can check the tag of a previous command for completion before finishing execution of a subsequent command. Accordingly, commands can be completed in a more timely manner to improve system performance.

According to one aspect of the present disclosure, a technique for handling commands includes assigning respective first tags to ordered commands included in an ordered command stream. Respective second tags are assigned to subsequent commands that follow an initial command (included in the ordered commands). Each of the respective second tags correspond to one the respective first tags that is associated with an immediate previous one of the ordered commands. The initial command is sent to an execution engine in a first cycle. At least one of the subsequent commands is sent to the execution engine prior to completion of execution of the initial command. In this manner, delay in execution of commands in an ordered command stream can be reduced. The execution engine may be implemented as a multiple entry queue with multiple fields (e.g., each queue entry may include an associated command tag field, a previous command tag field, and completion field that indicates whether the associated command has completed execution) and associated logic that checks the fields to verify that a prior command has completed execution before a subsequent command begins execution.

According to another aspect of the present disclosure, a memory controller includes an input/output interface and a coherency unit (for maintaining memory coherency) coupled to the input/output interface. The coherency unit includes an execution engine and is configured to receive an ordered input/output command stream via the input/output interface. The coherency unit is further configured to assign respective first tags to ordered commands included in the ordered input/output command stream and assign respective second tags to subsequent commands that follow an initial command (included in the ordered commands). Each of the respective second tags corresponds to one the respective first tags that is associated with an immediate previous one of the ordered commands. The initial command is sent to the execution engine in a first cycle and at least one of the subsequent commands is sent to the execution engine prior to completion of execution of the initial command.

According to one embodiment of the present disclosure, an input/output subsystem includes an input/output bridge that is configured to provide an ordered input/output command stream and a memory controller that is coupled to the input/output bridge. The memory controller includes a coherency unit that is configured to assign respective first tags to ordered commands included in the ordered input/output command stream and assign respective second tags to subsequent commands that follow an initial command included in the ordered commands. Each of the respective second tags correspond to one the respective first tags that is associated with an immediate previous one of the ordered commands. The coherency unit is further configured to send the initial command to an execution engine in a first cycle and send at least one of the subsequent commands to the execution engine prior to completion of execution of the initial command.

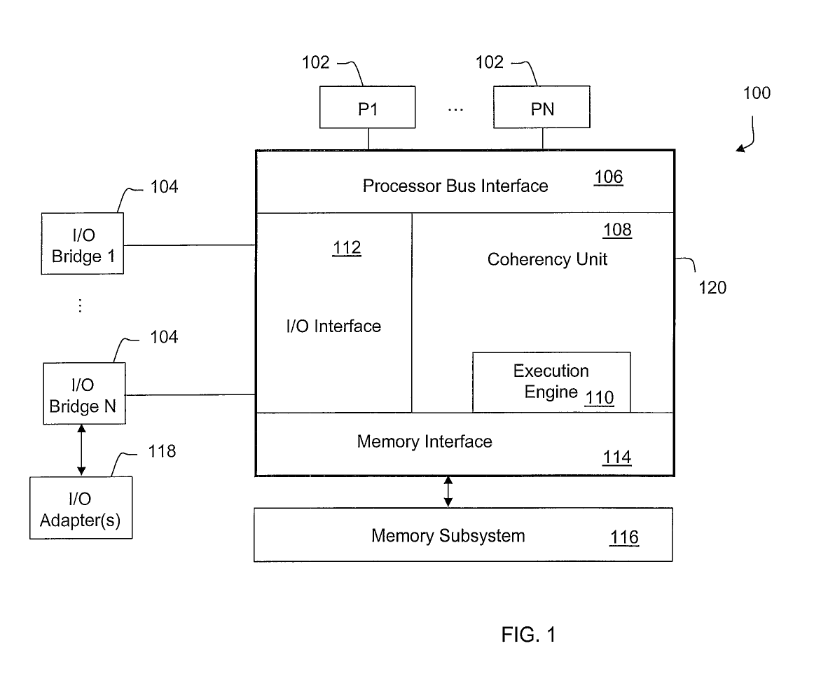

With reference to FIG. 1, an example processor system 100 is illustrated that includes multiple processors 102, which are coupled to a processor bus interface 106 of an integrated circuit (IC) 120, which may take the form of a memory controller (frequently referred to as a Northbridge) or an input/output (I/O) chip. The system 100 also includes multiple I/O bridges 104, each of which may be coupled to multiple I/O adapters 118 (e.g., Ethernet cards, peripheral component interconnect (PCI) cards, and hard disk drive (HDD) interfaces). The I/O bridges 104 are each coupled to an I/O interface 112 of the IC 120. The IC 120 includes a coherency unit 108 that is in communication with the I/O interface 112 and an execution engine 110 that is in communication with a memory interface 114, which is coupled to a memory subsystem 116. In at least one embodiment, the processors 102 each include a multi-level cache memory structure (not shown), e.g., a first level (L1) cache memory (cache) that is coupled to a second level (L2) cache memory (cache) 106. The processors 102 may also include multiple cores. The memory subsystem 112 includes an application appropriate amount of volatile and non-volatile memory.

In a system, such as the system 100, where each command is 64 bytes (Bs) wide, an internal system bus runs at 400 MHz, and a required system bus bandwidth is 7.5 GB/s, an execution engine can be configured to present commands (to the memory subsystem 116) with tags to maintain an execution order. As one example, for an ordered command stream that includes commands A, B, and C, that must complete in the order A, B, C: the command A may be presented to the system and assigned a tag of ‘4’; the command B may be presented to the system and assigned a tag of ‘5’ (which is ordered behind command A, which has a tag of ‘4’); and the command C may be presented to the system and assigned a tag of ‘6’ (which is ordered behind command B, which has a tag of ‘5’). To meet the 7.5 GB/s performance level, the commands A, B, and C must finish within ten cycles of each other. As noted above, traditionally, the command B could not be presented to a system (e.g., the memory subsystem 116) until the command A had completed.

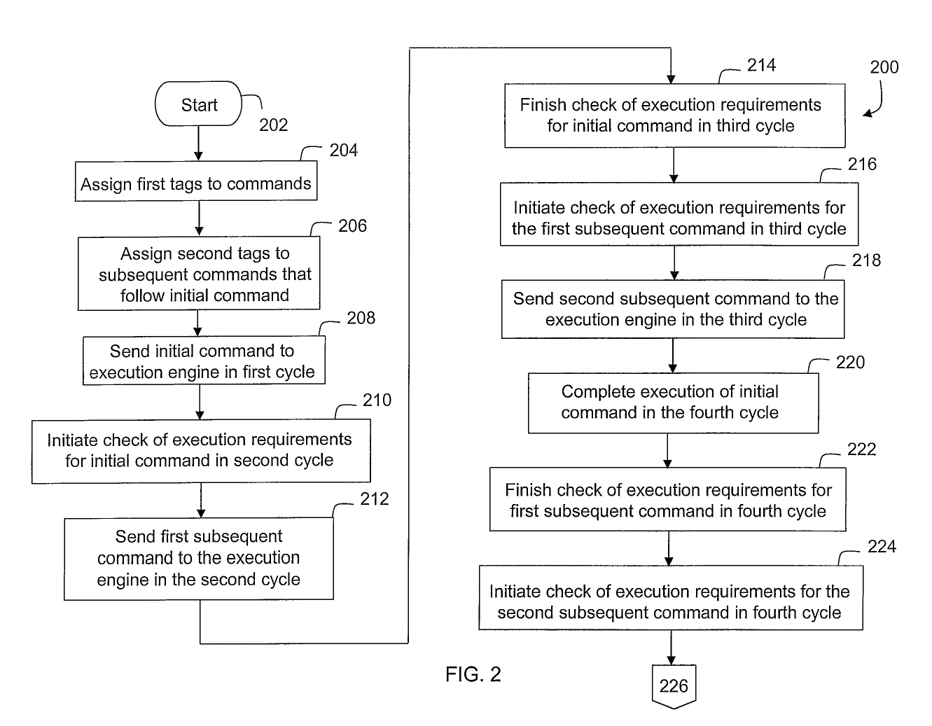

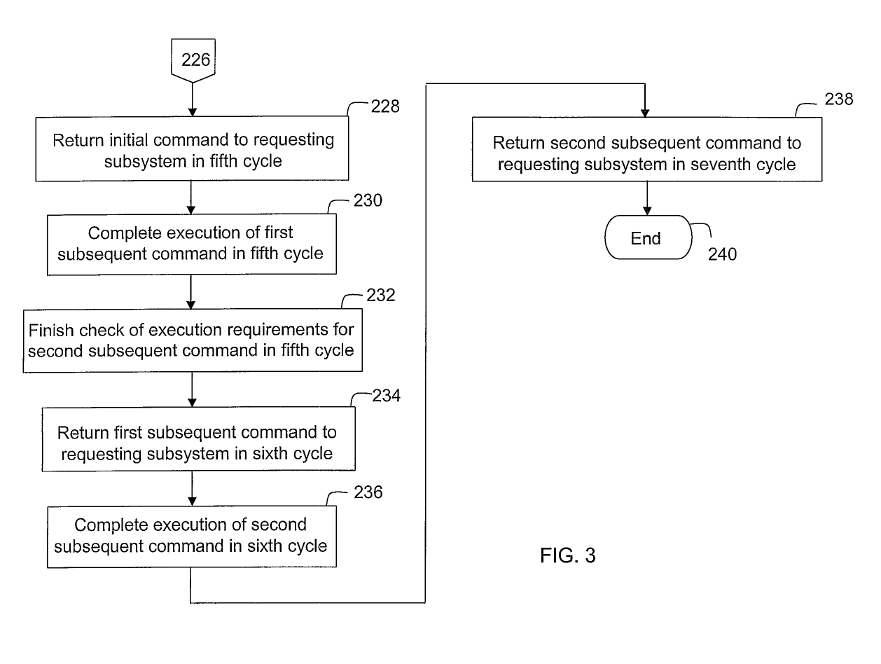

According to various aspects of the present disclosure, and with reference to FIGS. 2-3, a process 200 is illustrated that meets the performance requirements (7.5 GB/s) for an ordered command stream including the commands A, B, and C. In block 202 the process 200 is initiated at which point control transfers to block 204. In block 204, different first tags are assigned to the commands A, B, and C. Next, in block 206, different second tags are assigned to subsequent commands (commands B and C) that follow an initial command (command A). For example, the command A may be assigned a first tag of ‘4’, the command B may be assigned a first tag of ‘5’, and the command C may be assigned a first tag of ‘6’. In this case, the command B is assigned a second tag of ‘4’ and the command C is assigned a second tag of ‘5’. The command A may be assigned a second tag of, for example, ‘0’ to indicate that execution of the command A is not dependent on another command. Then, in block 208, in a first cycle (cycle 1), the command A (an initial command) is sent to an execution engine. Next, in block 210, in a second cycle (cycle 2), the command A begins checking for execution requirements. Then, in block 212, also during the second cycle, the command B (first subsequent command) is sent to the execution engine along with the tag of the command A (indicating that execution of command B has to wait for execution of command A, which has a tag of ‘4’). Next, in a third cycle (cycle 3), the command A finishes checking execution requirements (block 214), the command B begins checking execution requirements (block 216), and the command C (second subsequent command) is sent to the execution engine along with the tag of the command B (indicating that the execution of the command C has to wait for the execution of the command B, which has a tag of ‘5’) (block 218).

Then, in a fourth cycle (cycle 4), the command A completes (block 220), the command B finishes checking execution requirements and is marked ready to execute since command A (with a tag of ‘4’) has completed (block 222), and the command C begins checking execution requirements (block 224). In a fifth cycle (cycle 5), the command A is returned to the part of the system (or subsystem) that requested execution (block 228), the command B is completed (block 230), and the command C finishes checking execution requirements and is marked ready to execute since the command B (with a tag of ‘5’) has completed (block 232). In a sixth cycle (cycle 6), the command B is returned to the part of the system (or subsystem) that requested execution (block 234) and the command C is completed (block 236). Finally, in a seventh cycle (cycle 7), the command C is returned to the part of the system (or subsystem) that requested execution (block 238). The process 200 then terminates in block 240. In a traditional system, the execution of the commands A, B, and C would have typically taken fifteen cycles to complete, instead of seven cycles, which severely limits system performance and would not meet a 7.5 GB/s performance level.

It should be appreciated that according to the techniques disclosed herein, if a subsequent command does not receive an indication of the completion of a previous command, the subsequent command will not progress (to maintain ordering of the ordered command stream). Command progress may be facilitated through implementation of a transaction ID, a ‘wait for transaction’ ID, and a ‘wait for ID valid’ bit. Logic for checking the bits may be implemented within the execution engine 110. In this case, an execution engine 110 updates (resets) the ‘wait for ID valid’ field when a command with the transaction ID that matched the ‘wait for transaction’ ID field completes, thus, allowing a waiting command to begin execution.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” (and similar terms, such as includes, including, has, having, etc.) are open-ended when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of handling commands, comprising:
assigning respective first tags to ordered commands included in an ordered command stream;
assigning respective second tags to subsequent commands that follow an initial command included in the ordered commands, wherein each of the respective second tags correspond to one the respective first tags that is associated with an immediate previous one of the ordered commands;
sending the initial command to an execution engine in a first cycle; and
sending at least one of the subsequent commands to the execution engine prior to completion of execution of the initial command.

2. The method of claim 1, further comprising:
initiating checking execution requirements for the initial command in a second cycle; and
sending a first one of the subsequent commands to the execution engine during the second cycle.

3. The method of claim 2, further comprising:
finishing the checking execution requirements for the initial command during a third cycle;
initiating checking execution requirements for the first one of the subsequent commands in the third cycle; and
sending a second one of the subsequent commands to the execution engine during the third cycle.

4. The method of claim 3, further comprising:
completing execution of the initial command during a fourth cycle.
finishing the checking execution requirements for the first one of the subsequent commands during the fourth cycle; and
initiating checking execution requirements for the second one of the subsequent commands in the fourth cycle.

5. The method of claim 4, further comprising:
returning the initial command to a subsystem that requested execution of the initial command during a fifth cycle;
completing execution of the first one of the subsequent commands during the fifth cycle; and
finishing the checking execution requirements for the second one of the subsequent commands in the fifth cycle.

6. The method of claim 5, further comprising:
returning the first one of the subsequent commands to the subsystem that requested execution of the first one of the subsequent commands during a sixth cycle; and
completing execution of the second one of the subsequent commands during the sixth cycle.

7. The method of claim 6, further comprising:
returning the second one of the subsequent commands to the subsystem that requested execution of the second one of the subsequent commands during a seventh cycle.

8. The method of claim 1, wherein the ordered command stream is an ordered direct memory access input/output command stream.

9. A memory controller, comprising:
an input/output interface; and
a coherency unit coupled to the input/output interface, wherein the coherency unit includes an execution engine and is configured to receive an ordered input/output command stream via the input/output interface, wherein the coherency unit is further configured to:
assign respective first tags to ordered commands included in the ordered input/output command stream;
assign respective second tags to subsequent commands that follow an initial command included in the ordered commands, wherein each of the respective second tags correspond to one the respective first tags that is associated with an immediate previous one of the ordered commands;
send the initial command to the execution engine in a first cycle; and
send at least one of the subsequent commands to the execution engine prior to completion of execution of the initial command.

10. The memory controller of claim 9, wherein the execution engine is configured to initiate checking execution requirements for the initial command in a second cycle and the coherency unit is configure to send a first one of the subsequent commands to the execution engine during the second cycle.

11. The memory controller of claim 10, wherein the execution engine is further configured to finish the checking execution requirements for the initial command in a third cycle and initiate checking execution requirements for the first one of the subsequent commands in the third cycle, and wherein the coherency unit is configured to send a second one of the subsequent commands to the execution engine in the third cycle.

12. The memory controller of claim 11, wherein the execution engine is further configured to:
complete execution of the initial command during a fourth cycle;
finish the checking execution requirements for the first one of the subsequent commands during the fourth cycle; and
initiate checking execution requirements for the second one of the subsequent commands in the fourth cycle.

13. The memory controller of claim 12, wherein the execution engine is further configured to:
return the initial command to a subsystem that requested execution of the initial command during a fifth cycle;
complete execution of the first one of the subsequent commands during the fifth cycle; and
finish the checking execution requirements for the second one of the subsequent commands in a fifth cycle.

14. The memory controller of claim 13, wherein the execution engine is further configured to:
return the first one of the subsequent commands to the subsystem that requested execution of the first one of the subsequent commands during a sixth cycle; and
complete execution of the second one of the subsequent commands during a sixth cycle.

15. The memory controller of claim 14, wherein the execution engine is further configured to:
return the second one of the subsequent commands to the subsystem that requested execution of the second one of the subsequent commands during a seventh cycle.

16. An input/output subsystem, comprising:
an input/output bridge configured to provide an ordered input/output command stream; and
a memory controller coupled to the input/output bridge, wherein the memory controller includes:
a coherency unit configured to:
assign respective first tags to ordered commands included in the ordered input/output command stream;
assign respective second tags to subsequent commands that follow an initial command included in the ordered commands, wherein each of the respective second tags correspond to one the respective first tags that is associated with an immediate previous one of the ordered commands;
send the initial command to an execution engine in a first cycle; and
send at least one of the subsequent commands to the execution engine prior to completion of execution of the initial command.

17. The input/output subsystem of claim 16, further comprising:
an input/output adapter coupled to the input/output bridge.

18. The input/output subsystem of claim 16, further comprising:
a memory subsystem coupled to the memory controller.

19. The input/output subsystem of claim 16, wherein the execution engine is included within the coherency unit.

20. The input/output subsystem of claim 16, wherein the ordered input/output command stream corresponds to a direct memory access command stream associated with an input/output adapter that is coupled to the input/output bridge.
